(19) United States
(12) Patent Application Publication
(10) Pub. No.: US 2014/0181109 A1
(43) Pub. Date: Jun. 26, 2014

(54) SYSTEM AND METHOD FOR ANALYSING TEXT STREAM MESSAGE THEREOF

(71) Applicant: Industrial Technology Research Institute, Hsinchu (TW)

(72) Inventors: Shun-Chieh Lin, Tainan City (TW); Chi-Chun Hsia, Kaohsiung City (TW); Huan-Wen Tsai, Hsinchu City (TW); Chung-Hong Lee, Kaohsiung City (TW)

(73) Assignee: Industrial Technology Research Institute, Hsinchu (TW)

(21) Appl. No.: 14/074,651

(22) Filed: Nov. 7, 2013

(30) Foreign Application Priority Data
Dec. 22, 2012 (TW) 101149250
Jul. 9, 2013 (TW) 102124478

(51) Int. Cl. G06F 17/30

(52) U.S. Cl. CPC G06F 17/3071
USPC 707/737

(57) ABSTRACT

A system and method for analyzing text stream message for a micro-blog are provided. The system includes a sliding window module, storing a plurality of text stream messages from the micro-blog and updating the plurality of text stream messages once every preset duration; a dynamic text weight module, receiving the plurality of text stream messages and calculating the plurality of text stream messages for generating a burst weight according to a dynamic text stream weight algorithm; a clustering module, clustering the plurality of text stream messages for generating a plurality of clusters by a clustering algorithm according to the plurality of text stream messages and the burst weight; and a memory device, storing the clusters.

### CROSS REFERENCE TO RELATED APPLICATIONS

This Application claims priority of Taiwan Patent Application No. 101149250, filed on Dec. 22, 2012 and Taiwan Patent Application No. 102124478 field on Jul. 9, 2013, the entireties of which are incorporated by reference herein.

### BACKGROUND

1. Technical Field

The disclosure is related to system and method for analyzing text stream messages, and related to the analysis of network real time messages thereof.

2. Description of the Related Art

A blog is a network platform for users to publish their comment and communicate with friends. Micro-blogs, such as Twitter, and Plurk, are popular network community platforms. Users can publish their daily trifles, share their daily lives, and get updates on friends, via the micro-blog.

Because the micro-blog gathers real time information of specific topics, it generates big influence on news, economy, politics, and society. The micro-blog promotes everyone's concern over popular topics (events) of the world. For example, when natural disasters or mass movement occurs, local residents may provide real time information through micro-blogs, thus, it's helpful to analyze the evolution of the real time information.

The words of text stream messages of micro-blogs are usually less than 140 characters, such as Twitter. Therefore, there are few features in a micro-blog message and concept-drift phenomenon would occur on a topic in these features in different time duration. Concept-drift occurs when the meaning of the topic changes in different time duration. Popular keywords of a topic will vary over the topic evolves with time. For example, a tsunami occurs; therefore the word “tsunami” is a popular word. With the topic evolves, the tsunami leads a nuclear disaster. Then the word “tsunami” is not so popular in this topic, and other words such as “nuclear”, become more popular in this topic. That is the popularity of the word “tsunami” decreases, and popularity of the word “nuclear” increases. A concept-drift occurs when the popularity of the word “tsunami” and the word “nuclear” are changed. Therefore, the real time topic would be clustered and observed to determine whether the real time topic is a popular topic. Data mining is applied to process the messages of the real time topic. For general micro-blogs, data mining technology can be divided into two types: graph mining; and text mining. Graph mining is applied for analyzing the graphic relationship between messages, and text mining is applied for analyzing text content of messages for detecting and tracking topics. Therefore, text stream mining technology is applied to analyze real time topics, wherein the text stream mining technology comprises Micro-blogging Topic Detection and Tracking and Text Stream Mining studying groups.

In Term Frequency-Inverse Document Frequency (TF-IDF) technology, Term Frequency (TF) is affected by the length of topic data, therefore, it may not be objective when dealing with different length of text message. Although the Inverse Document Frequency (IDF) would weight the words over the text messages, it may be not suitable for detecting popular topics.

Therefore, how to provide a stream message analyzing method for users to get real time information from the large numbers of topics in micro-blogs rapidly and accurately will become important.

### BRIEF SUMMARY

An embodiment of the disclosure provides a system for analyzing text stream messages, comprising: a sliding window module, storing a plurality of text stream messages and updating the plurality of text stream messages by a sliding window once every preset duration; a dynamic text weight module, receiving the plurality of text stream messages and calculating the plurality of text stream messages for generating a burst weight according to a dynamic text stream weight algorithm; and a clustering module, clustering the plurality of text stream messages by a clustering algorithm according to the plurality of text stream messages and the burst weight for generating a plurality of clusters and selecting one or more than one keyword with higher burst weight in each of the clusters as concept words, wherein as the concept words of the clusters vary with time, the time varying sequence of concept words are identified as the concept words sequence denoting the concept drift of the clusters; and a memory device, storing the clusters which are clustered by the clustering module.

An embodiment of the disclosure provides a method for analyzing text stream messages, comprising: storing a plurality of text stream messages and updating the plurality of text stream messages by a sliding window once every preset duration; receiving the plurality of text stream messages and calculating the plurality of text stream messages for generating a burst weight according to a dynamic text stream weight algorithm; and clustering the plurality of text stream messages by a clustering algorithm according to the plurality of text stream messages and the burst weight for generating at least one cluster.

An embodiment of the disclosure provides a system for analyzing text stream messages, comprising: an analyzing device, comprising: a sliding window module, storing a plurality of text stream messages and updating the plurality of text stream messages by a sliding window once every preset duration; a dynamic text weight module, receiving the plurality of text stream messages and calculating the plurality of text stream messages for generating a burst weight according to a dynamic text stream weight algorithm; and a clustering module, clustering the plurality of text stream messages by a clustering algorithm according to the plurality of text stream messages and the burst weight for generating at least one cluster; a memory device, storing the clusters which are clustered by the clustering module; and an electrical device, displaying information of the clusters stored in the memory device.

### BRIEF DESCRIPTION OF THE DRAWINGS

The disclosure will become more fully understood by referring to the following detailed description with reference to the accompanying drawings, wherein:

FIG. 1 is a schematic diagram illustrating the plurality of text stream messages analyzing system 100 according to an embodiment of the disclosure;

FIG. 2 is a schematic diagram illustrating the sliding window module 110 according to an embodiment of the disclosure;

FIGS. 3A-3B are display interface diagrams illustrating of a displaying according to an embodiment of the disclosure;

FIG. 3C is a display interface diagram illustrating of a displaying according to another embodiment of the disclosure;

FIG. 4 is a flowchart 400 of a text stream message analyzing method according to an embodiment of the disclosure.

### DETAILED DESCRIPTION

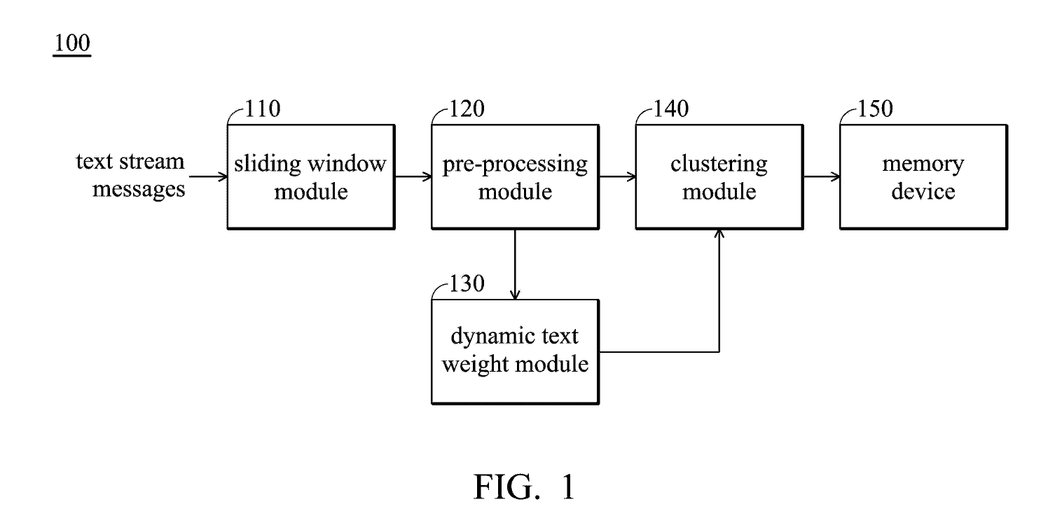

FIG. 1 is a schematic diagram illustrating the plurality of text stream messages analyzing system 100 according to an embodiment of the disclosure. In an embodiment of the disclosure, the plurality of text stream messages analyzing system 100 may be used for analyzing real time Internet, social network, and micro-blog messages, such as Twitter, and Plurk. In the FIG. 1, the plurality of text stream messages analyzing system 100 comprises a sliding window module 110, a pre-processing module 120, a dynamic text weight module 130, a clustering module 140 and a memory device 150.

In an embodiment of the disclosure, the sliding window module 110 comprises a sliding window for storing the text stream micro-blog messages, such as text stream messages from Twitter. Then, the stored text stream messages are updated by the sliding window once every preset duration. In addition, the sliding window module 110 is configured to delete the stored text stream messages of which the time points are out-of-date of the sliding window. The detailed description of the sliding window module 110 will introduced below.

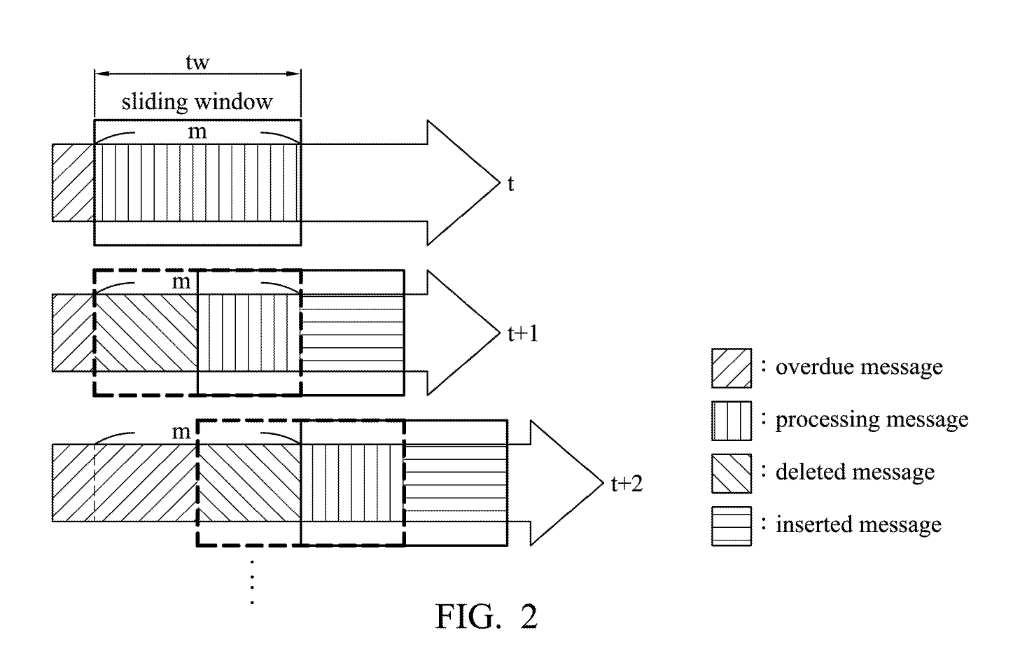

FIG. 2 is a schematic diagram illustrating the sliding window module 110 according to an embodiment of the disclosure. The embodiment takes a micro-blog for example. The content from the micro-blog are text stream messages with the feature of timing sequences, therefore the messages are transmitted by users. Therefore, in the embodiment, the sliding window module 110 is configured to process the messages by reserving and storing the messages in the latest specific time duration for analyzing the messages effectively. In the embodiment, the length of the sliding window is set as tw. When a new message m is inputted to the system at time point t, the message m will be deleted at t+tw. In FIG. 2, if a message m is processed in the system, the message m will be deleted after tw (at time point t+2). Therefore, the system may maintain the stored message in the memory by adding and deleting the messages by the sliding window module 110. In FIG. 2, the plurality of text stream messages may be classified into four types. The first type is overdue messages which are expressed by a left oblique line. The second type is processing messages which are expressed by a straight line. The third type is deleted messages which are expressed by a right oblique line and means that the time points of the messages are out-of-date of the sliding window at recent time point accordingly. For example, parts of the processing message at time point t may become a deleted message at time point t+1 when the sliding window is slid. The forth type is inserted messages which are expressed by a horizontal line, and means that new messages have been received and inserted in the sliding window module 110. Therefore, the messages may be updated by the sliding window module 110 and the content of messages stored in the memory may be maintained dynamically by adding and deleting the plurality of text stream messages from the micro-blog.

In an embodiment of the disclosure, a dynamic text weight module 130 is configured to receive the text stream messages, wherein the plurality of text stream messages received by the dynamic text weight module 130 are pre-processed by the pre-processing module 120 in advance. When being pre-processing, every text stream message is processed through a word segmentation or tokenization process and a sentence segmentation process, and after pre-processing, non-important words are filtered for generating at least one keyword. For example, the pre-processing module 120 may extract the keywords “global warming”, “Arctic”, “iceberg” and “sea level”, from the sentence, “global warming will make the icebergs in the Arctic melt as a result the sea levels rising”.

Because the importance of every keyword may be changed as time goes on, the dynamic text weight module 130 has to provide different weighted values for every keyword at different time points according to concept-drift. The dynamic text weight module 130 calculates the plurality of text stream messages which have been pre-processed by the pre-processing module 120, according to a dynamic text stream weight algorithm for generating burst weight, wherein in the dynamic text stream weight algorithm, the burst scores (BS) of the keywords and a Term Occurrence Probability (TOP) are calculated for generating burst weight. The weight_{w,t} is calculated according to the frequency of the keyword for reflecting the frequency of the keyword is increased or decreased, and it means the burst weighted value of a keyword w at time point t. In an embodiment, weight_{w,t} is generated according to two factors, BS_{w,t} and TOP_{w,t}. BS_{w,t} is the burst score of a keyword w at time point t and TOP_{w,t} is the probability of a keyword w occurring at time point t.

In an embodiment, the detailed mathematical formulas of weight_{w,t}, BS_{w,t} and TOP_{w,t} are expressed as follow:

$${weight}_{w , t} = {BS}_{w , t} * {TOP}_{w , t}$$

$${BS}_{w , t} = max \{ \frac{{ar}_{w , t} - {E}_{i} ( {ar}_{w , t} )}{E ( {ar}_{w , t} )} , 0 \}$$

$${TOP}_{w , t} = P ( {w}_{t} \vert {c}_{t} ) = \frac{\vert \{ m \text{:} {w}_{t} ∈ {c}_{t} \} \vert}{\vert {c}_{t} \vert}$$

, wherein ar_{w,t} is the arrival rate of a keyword w at time point t, E(ar_{w,t}) is the expected value of ar_{w,t}, P(wₜ/cₜ) is the conditional probability of a keyword w at time point t in the message set c, |{m:wₜ ∈ cₜ}| is the number of the keyword w in the message m at time point t in the message set c, and |cₜ| is the amount of the messages at time point t in the message set c. In an embodiment of the disclosure, the words of the plurality of text stream messages may be classified into three types, uninformative words, common words, and topic words, and the dynamic text weight module 130 provides different weighted values according to the importance of the three types of words.

For example, in the Table 1, some text stream messages have been received from Twitter:

TABLE 1

```
  472430065 | Thu Oct 04 07:59:53 CST 2012 | no TimeZone | US
Presidential Debate in a bit.......Obama v Mitt Romney! where is my
Pop Corn? |
  472443102 | Thu Oct 04 08:08:04 CST 2012 | Central Time
(US & Canada) | RT @Alexander1Great: Romney-Obama Presidential
Debate tonight. I will most likely fill your timeline with my thoughts.
So prepare to be ... |
  472473175 | Thu Oct 04 08:26:44 CST 2012 | no TimeZone | RT
@MensHumor: A presidential #debate tonight? I have a better Idea.
Obama and Romney: 5 Rounds in The Octagon. |
  472506759 | Thu Oct 04 08:46:49 CST 2012 | Eastern Time
(US & Canada) | Romney is about to go ham in the presidential debate
#heyoo #CNN |
```

In the Table 2, keywords such as “debate”, “Obama”, “presidential”, and “Romney” are extracted by the pre-processing module 120 from every text stream message.

TABLE 2

```
  472430065 | Thu Oct 04 07:59:53 CST 2012 | no TimeZone |
<debate, obama, mitt, presidential, romney> |
  472443102 | Thu Oct 04 08:08:04 CST 2012 | Central Time
(US & Canada) | <debate, tonight, obama, presidential, romney> |
  472473175 | Thu Oct 04 08:26:44 CST 2012 | no TimeZone |
<debate, tonight, obama, presidential, romney> |
  472506759 | Thu Oct 04 08:46:49 CST 2012 | Eastern Time
(US & Canada) | <romney, ham, presidential, debate, cnn> |
```

And then, in the Table 3, the dynamic text weight module 130 calculates the plurality of text stream messages which have been pre-processed by the pre-processing module 120, according to a dynamic text stream weight algorithm for generating burst weight.

TABLE 3

```
  472430065 | Thu Oct 04 07:59:53 CST 2012 | no TimeZone |
<debate:0.35410212719614037, obama:0.07005646469507887,
mitt:0.05313226939244977, presidential:0.21947773819604818,
romney:0.058488552840998895> |
  472443102 | Thu Oct 04 08:08:04 CST 2012 | Central Time
(US & Canada) | <debate:0.35410212719614037, tonight:
0.036082594431746204, obama:0.07005646469507887,
presidential:0.21947773819604818, romney:0.058488552840998895> |
  472473175 | Thu Oct 04 08:26:44 CST 2012 | no TimeZone |
<debate:0.35410212719614037, tonight:0.036082594431746204,
obama:0.07005646469507887, presidential:0.21947773819604818,
romney:0.058488552840998895> |
  472506759 | Thu Oct 04 08:46:49 CST 2012 | Eastern Time
(US & Canada) | <romney:0.058488552840998895, ham:
2.1594359238101554E-4, presidential:0.21947773819604818,
debate:0.35410212719614037, cnn:0.013875124254119355> |
```

In an embodiment of the disclosure, the clustering module 140 is configured to cluster the plurality of text stream messages which have been pre-processed by the pre-processing module 120 by a cluster algorithm for generating at least one cluster, wherein the clustering module 140 clusters the plurality of text stream messages by processing a similarity estimation according to the different keywords and the burst weight of keywords. Each of the clusters which is clustered by the clustering module 140 us a detected topic and one or more than one keyword with higher burst weight in each of the clusters are selected as concept words, wherein as the concept words of the clusters vary with time, the time varying sequence of concept words are identified as the concept words sequence denoting the concept drift of the clusters.

According to the above example, in the Table 4, the two messages have four keywords, “debate”, “Obama”, “presidential”, “Romney” and the time difference of the two message are (Thu Oct 04 08:08:04 CST 2012−Thu Oct 04 07:59:53 CST 2012=1349309284−1349308793=491). In addition, the window length is 7200. Therefore, the similarity estimation is as follow:

TABLE 4

```
  472430065 | Thu Oct 04 07:59:53 CST 2012 | no TimeZone |
<debate:0.35410212719614037, obama:0.07005646469507887,
mitt:0.05313226939244977, presidential:0.21947773819604818,
romney:0.058488552840998895> |
  472443102 | Thu Oct 04 08:08:04 CST 2012 | Central Time
(US & Canada) | <debate:0.35410212719614037, tonight:
0.036082594431746204, obama:0.07005646469507887,
  presidential:0.21947773819604818, romney:
  0.058488552840998895> | ((debate:0.35410212719614037 +
obama:0.07005646469507887 + presidential:
0.21947773819604818 + romney:0.058488552840998895)/1)
* e((−0.5)*(491)/7200) = 0.702124882928266315 *
0.9664775369758356 = 0.67858792750195774928023435645781
```

In an embodiment of the disclosure, if the similarity estimated by the clustering module 140 is more than a threshold, the two messages will be added in the same cluster, and if the similarity estimated by the clustering module 140 less than a threshold, the two messages will be deleted. For example, if the threshold is set to 0.6 and the similarity of the two messages is 0.68, the two messages will be added in the same cluster. Namely, in the embodiment of the disclosure, the cluster algorithm has two stages: a deleting stage and adding stage. The deleted stage is divided to three methods for handling messages. The three methods are: Removal, Reduction and Potential. The added stage is divided to four cases: Noise, Creation, Absorption and Merge, wherein the Creation means that a new cluster was created, Absorption means that elements in some clusters have been absorbed, and Merge means that it is determined whether the clusters may be merged according to the sum score of the burst weight of the same keywords whose similarity may be more than a threshold in the clusters.

In an embodiment of the disclosure, the memory device 150 is configured to collect and store the clusters corresponding to different topics after the above clustering process. In an embodiment of the disclosure, the memory device 150 comprises a cloud data base established by a cloud method. In an embodiment of the disclosure, the memory device 150 may gather the collected and stored data to a topic abstract and transmit the topic abstract to the client electrical device, such as desktop computer, smart phone, or tablet, for providing users for watching and searching. In an embodiment of the disclosure, the sliding window module 110, the pre-processing module 120, the dynamic text weight module 130 and the clustering module 140 may be integrated in an analyzing device (not expressed in FIG. 1).

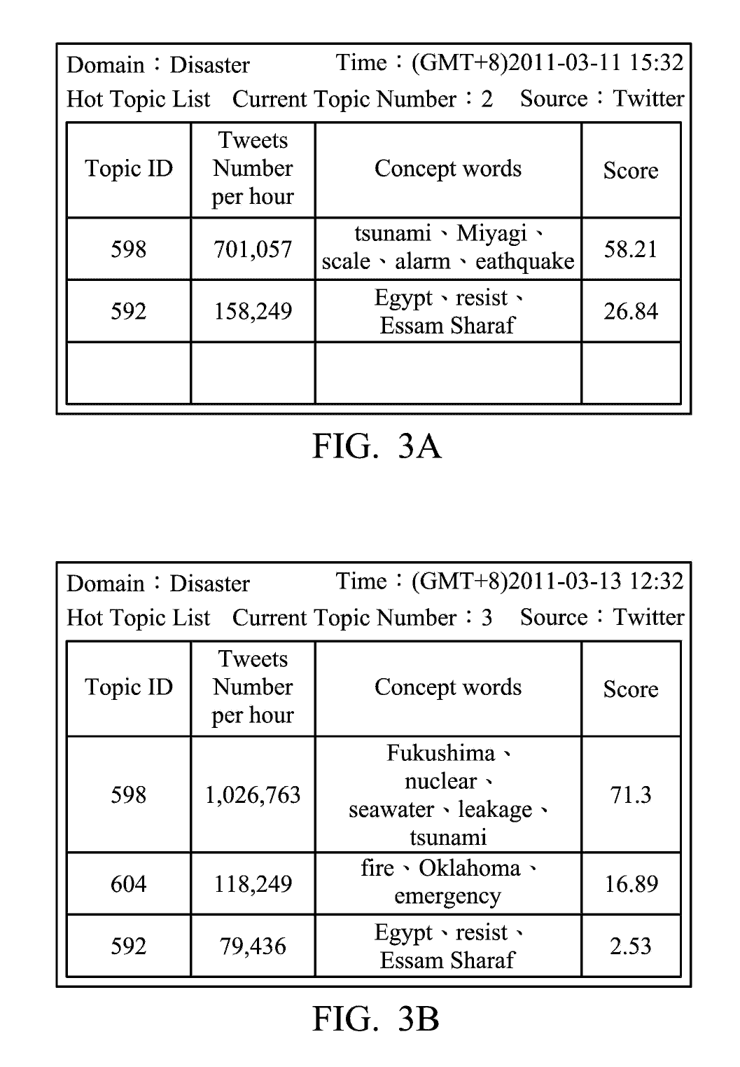

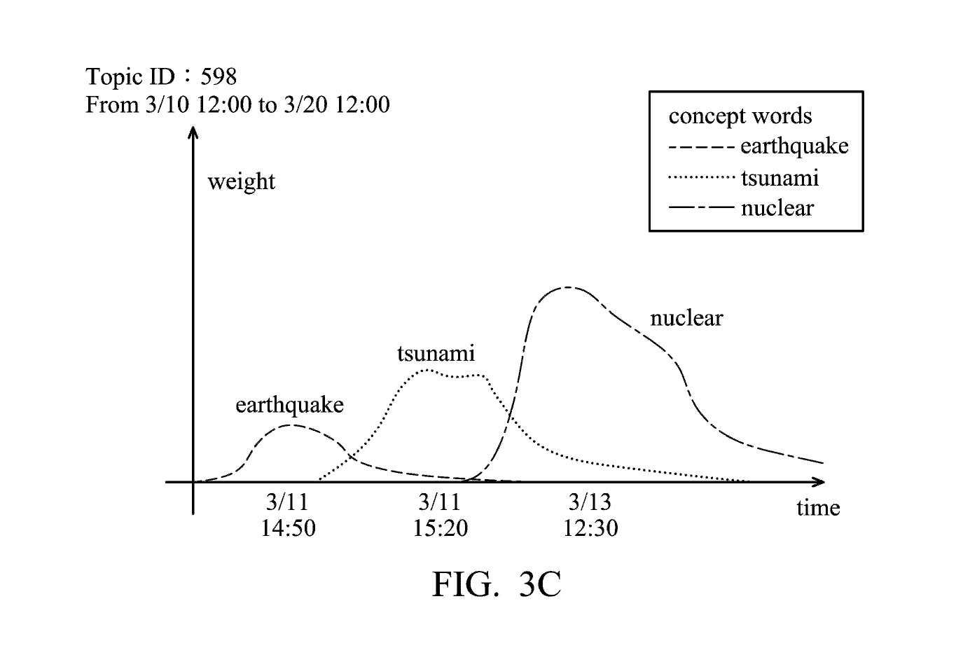

In an embodiment of the disclosure, the plurality of text stream messages analyzing system 100 further comprises a displaying device (not expressed in FIG. 1). The displaying device is configured to display the clusters corresponding to different topics in the memory device 150. FIGS. 3A-3B are display interface diagrams illustrating of a displaying according to embodiments of the disclosure. In the FIG. 3A-3B, the display interface displays the detected topics (such as the topic 598 and topic 592 in FIG. 3A) which are the output result of the clustering modules. In addition, the concept words corresponding to the topics, the data and time of the topics, and the number of the tweets comprised in the topics are displayed in the display interface. The display interfaces in the FIGS. 3A-3B are the same display interface; they display the results in different time points respectively. In FIG. 3A (the first time point), in the topic with the highest topic score, we can know that the earthquake is happened and the alarm of the tsunami is generated, therefore, the concept words such as “tsunami”, “alarm”, “earthquake” are displayed. In the FIG. 3B (the second time point), the time point is happened after the nuclear disaster, therefore, in the same topic, the concept words such as “Fukushima”, “nuclear” are displayed, too.

One or more than one keyword with the most occurring times can be selected as the concept word(s) for each topic. Or one or more than one keywords with higher burst weight can be selected as the concept word(s) for each topic. Other algorithm such as term frequency-inverse document frequency (TF-IDF) algorithm can also be adopted as the concept word selection criterion. In addition, the concept words for each topic can be selected by selecting one or more than one keyword according to above method respectively, and then assembling the keywords from different methods.

Every cluster cₜ clustered from the clustering module 140 at time point t can be identified as a detected topic. The topic energy te_{c}_{ₜ} comprises three factors, p_{c}_{ₜ} (the popularity of the topic at the time point t), b_{c}_{ₜ} (the burstiness of the topic at time point t), and (informativeness of the topic at time point t):

$${te}_{{c}_{t}} = {p}_{{c}_{t}} \cdot {b}_{{c}_{t}} \cdot {i}_{{c}_{t}}$$

$${p}_{{c}_{t}} = {n}_{m , {c}_{t}}$$

$${i}_{{c}_{t}} = \frac{\# distWords ∈ {c}_{t}}{{n}_{w , {c}_{t }}}$$

$${b}_{{c}_{t}} = {\sum }_{j = 1}^{\# distWords ∈ {c}_{t}} {BS}_{{w}_{{c}_{t} , j}}$$

wherein n_{m,c}_{ₜ} is the number text messages of topic cₜ;

#distWords ∈ cₜ denotes the number of distict keywords in the topic cₜ;

n_{w,c}_{ₜ} is the total number of the keywords in the topic cₜ;

w_{c}_{ₜ}_{,j} is the jₜₕ keyword in the topic cₜ;

BS_{w}_{_{ct,j}} is the burst weight of the jₜₕ keyword in the topic cₜ.

FIG. 3C is a display interface diagram illustrating of a displaying according to another embodiment of the disclosure. In FIG. 3C, user can know the evolution with time of the concept words in detected topics from the cloud database. Specifically, user can select the topic he/she interested in (such as topic 598). After selecting, the display interface of the FIG. 3C may display the evolution with time of the concept words in the topic from the cloud database. In FIG. 3C, when the topic 598 is happened, the concept word is “earthquake” first, as time goes by, the concept word is changed to “tsunami” then changed to “unclear” at last. Therefore, user can track the evolution of the topic by the display interface rather than track three different topics.

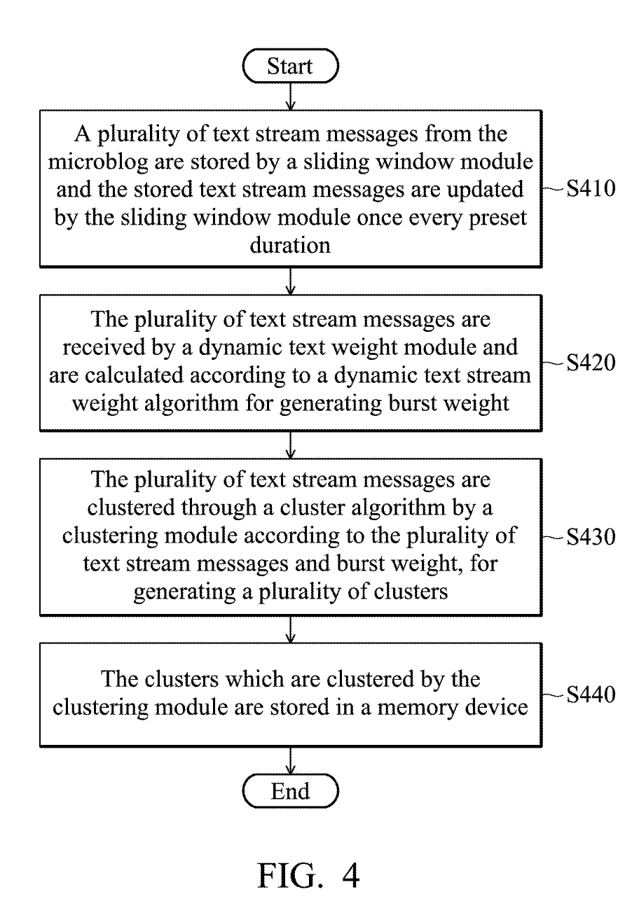

FIG. 4 is a flowchart 400 of a text stream message analyzing method according to an embodiment of the disclosure. The plurality of text stream messages analyzing method is applied for analyzing a micro-blog. Firstly, in step S410, a plurality of text stream messages from the micro-blog are stored by a sliding window module and the stored text stream messages are updated by the sliding window module once every preset duration. In step S420, the plurality of text stream messages are received by a dynamic text weight module and are calculated according to a dynamic text stream weight algorithm for generating burst weight. In step S430, the plurality of text stream messages are clustered through a cluster algorithm by a clustering module according to the plurality of text stream messages and burst weight, for generating a plurality of clusters. In step S440, the clusters which are clustered by the clustering module are stored in a memory device.

In an embodiment of the disclosure, the plurality of text stream messages analyzing method further comprises the plurality of text stream messages being deleted by the sliding window module once every preset duration, when the time points of the stored text stream messages are out-of-date of the sliding window.

In an embodiment of the disclosure, the plurality of text stream messages received by the dynamic text weight module has to be pre-processed by the pre-processing module 120. When being pre-processing, every text stream message is processed through a word segmentation or tokenization process and a sentence segmentation process, and after pre-processing, non-important words are filtered out to generate a plurality of keywords. In an embodiment of the disclosure, the plurality of text stream messages analyzing method further comprises burst scores (BS) and a Term Occurrence Probability (TOP) of the keywords are calculated via the dynamic text stream weight algorithm for generating burst weight.

In an embodiment of the disclosure, the plurality of text stream messages are clustered through the cluster algorithm according to the plurality of text stream messages and the burst weight to process a similarity estimation for generating the clusters. In an embodiment of the disclosure, the memory device comprises a cloud data base established by a cloud method for storing the clusters which are clustered by the clustering module.

In the traditional method, the parameters are fixed as a result the method is not applied properly for detecting unknown amount of topics and the method need more calculating time as a result the method is not applied properly for real time topic detection. In addition, the traditional weighting method cannot present the variety of dynamic weighted values of the text stream messages, thus, it can not overcome the concept-drift problem of the text stream messages. The text stream messages of the disclosure may be added and deleted by a sliding window module to maintain the system dynamically. The importance of the messages, changing as time goes by, is detected through the dynamic text weight technology. Continuous messages are clustered by the clustering module immediately. When real time topics are detected and the clusters of the topics are generated, the clusters of the topics will be stored in a cloud data base. Therefore, the method is helpful to analyze the evolution of the real time topics for the variety and impact of market and achieve the goals of the market development of products or the disaster warning function.

The above paragraphs describe many aspects of the disclosure. Obviously, the teaching of the disclosure can be accomplished by many methods, and any specific configurations or functions in the disclosed embodiments only present a representative condition. Those who are skilled in this technology can understand that all of the disclosed aspects in the disclosure can be applied independently or be incorporated.

While the disclosure has been described by way of example and in terms of embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A system for analyzing text stream messages, comprising:
a sliding window module, storing a plurality of text stream messages and updating the plurality of text stream messages once every preset duration;
a dynamic text weight module, receiving the plurality of text stream messages and calculating the plurality of text stream messages for generating a burst weight according to a dynamic text stream weight algorithm; and
a clustering module, clustering the plurality of text stream messages by a clustering algorithm according to the plurality of text stream messages and the burst weight for generating at least one cluster.

2. The system of claim 1, wherein the sliding window module deletes the plurality of text stream messages of which the time points of the plurality of text stream messages are out-of-date of the sliding window, once every preset duration.

3. The system of claim 1, further comprising:
a pre-processing module, wherein the plurality of text stream messages received by the dynamic text weight module is pre-processed through a word segmentation or tokenization process and a sentence segmentation process, for generating a plurality of keywords.

4. The system of claim 3, wherein the dynamic text weight module calculates a burst scores (BS) and a Term Occurrence Probability (TOP) of the keywords via the dynamic text stream weight algorithm for generating the burst weight.

5. The system of claim 1, wherein the clustering module clusters the plurality of text stream messages through the cluster algorithm by processing a similarity estimation according to the plurality of text stream messages and the burst weight, and selecting one or more than one keyword with higher burst weight in each of the clusters and one or more than one keyword with higher TF-IDF as concept words, wherein as the concept words of the clusters vary with time, the time varying sequence of concept words are identified as the concept words sequence denoting the concept drift of the clusters.

6. The system of claim 1, wherein the clustering module clusters the plurality of text stream messages through the cluster algorithm by processing a similarity estimation according to the plurality of text stream messages and the burst weight, and selecting one or more than one keyword with higher burst weight in each of the clusters or one or more than one keyword with higher TF-IDF as concept words, wherein as the concept words of the clusters vary with time, the time varying sequence of concept words are identified as the concept words sequence denoting the concept drift of the clusters.

7. The system of claim 1, further comprising:
a memory device, storing the clusters which are clustered by the clustering module.

8. The system of claim 1, wherein the memory device comprises a cloud database.

9. A method for analyzing text stream messages, comprising:
storing a plurality of text stream messages and updating the plurality of text stream messages once every preset duration;
receiving the plurality of text stream messages and calculating the plurality of text stream messages for generating a burst weight according to a dynamic text stream weight algorithm; and
clustering the plurality of text stream messages by a clustering algorithm according to the plurality of text stream messages and the burst weight for generating at least one cluster.

10. The method of claim 9, further comprising:
deleting the plurality of text stream messages the time points are out-of-date of the sliding window preset duration.

11. The method of claim 9, wherein the received plurality of text stream messages is pre-processed through a word segmentation or tokenization process and a sentence segmentation process, for generating a plurality of keywords.

12. The method of claim 11, further comprising:
calculating a burst scores (BS) and a Term Occurrence Probability (TOP) of the keywords via the dynamic text stream weight algorithm for generating the burst weight.

13. The method of claim 9, wherein clustering the plurality of text stream messages by the cluster algorithm is processed by a similarity estimation according to the plurality of text stream messages and the burst weight, wherein one or more than one keyword with higher burst weight in each of the clusters and one or more than one keyword with higher TF-IDF are selected as concept words, and wherein as the concept words of the clusters vary with time, the time varying sequence of concept words are identified as the concept words sequence denoting the concept drift of the clusters.

14. The method of claim 9, wherein clustering the plurality of text stream messages by the cluster algorithm is processed by a similarity estimation according to the plurality of text stream messages and the burst weight, wherein one or more than one keyword with higher burst weight in each of the clusters or one or more than one keyword with higher TF-IDF are selected as concept words, and wherein as the concept words of the clusters vary with time, the time varying sequence of concept words are identified as the concept words sequence denoting the concept drift of the clusters.

15. The method of claim 9, further comprising:
storing the clusters.

16. The method of claim 15, wherein the stored clusters are stored in a cloud database.

17. A system for analyzing text stream messages, comprising:
an analyzing device, comprising:
a sliding window module, storing a plurality of text stream messages and updating the plurality of text stream messages once every preset duration;
a dynamic text weight module, receiving the plurality of text stream messages and calculating the plurality of text stream messages for generating a burst weight according to a dynamic text stream weight algorithm; and
a clustering module, clustering the plurality of text stream messages by a clustering algorithm according to the plurality of text stream messages and the burst weight for generating at least one cluster;
a memory device, storing the clusters which are clustered by the clustering module; and
an electrical device, displaying information of the clusters stored in the memory device.

18. The system of claim 17, wherein the sliding window module deletes the plurality of text stream messages of which the time points are out-of-date of the sliding window, once every preset duration.

19. The system of claim 17, further comprising:
a pre-processing module, wherein the plurality of text stream messages received by the dynamic text weight module are pre-processed through a word segmentation or tokenization process and a sentence segmentation process, for generating a plurality of keywords.

20. The system of claim 19, wherein the dynamic text weight module calculates a burst scores (BS) and a Term Occurrence Probability (TOP) of the keywords via the dynamic text stream weight algorithm for generating the burst weight.

21. The system of claim 17, wherein the clustering module clusters the plurality of text stream messages through the cluster algorithm by processing a similarity estimation according to the plurality of text stream messages and the burst weight, and selecting one or more than one keyword with higher burst weight in each of the clusters and one or more than one keyword with higher TF-IDF as concept words, wherein as the concept words of the clusters vary with time, the time varying sequence of concept words are identified as the concept words sequence denoting the concept drift of the clusters.

22. The system of claim 17, wherein the clustering module clusters the plurality of text stream messages through the cluster algorithm by processing a similarity estimation according to the plurality of text stream messages and the burst weight, and selecting one or more than one keyword with higher burst weight in each of the clusters or one or more than one keyword with higher TF-IDF as concept words, wherein as the concept words of the clusters vary with time, the time varying sequence of concept words are identified as the concept words sequence denoting the concept drift of the clusters.

23. The system of claim 17, wherein the memory device comprises a cloud database.
